(19) United States
(12) Patent Application Publication
(10) Pub. No.: US 2007/0199217 A1
(43) Pub. Date: Aug. 30, 2007

(54) Chemo-illuminated flag

(76) Inventor: Alex De Jong, Fullerton, CA (US)

Correspondence Address: PATENT LAW & VENTURE GROUP, 2424 S.E. BRISTOL, SUITE 300, NEWPORT BEACH, CA, 92660, US

(21) Appl. No.: 11/365,343

(22) Filed: Feb. 28, 2006

(51) Int. Cl. G09F 13/20

(52) U.S. Cl. 40/542

(57) ABSTRACT

An illuminating display apparatus has a flexible sheet formed with two independent recessed areas separated by a wall. The sheet is formed with a raised perimeter surface surrounding the recessed areas. A porous wall separates one of the recessed areas into a first and a second open compartments. A closed container of a frangible material is placed within one of the compartments and the container is filled with a first chemiluminescent fluid. A second rigid sheet has a first surface area portion that is either transparent or translucent; and a second surface area portion that is opaque. The two sheets are bonded together forming closed compartments within one of which the frangible container is held in place. The compartments are filled with a second chemiluminescent fluid. When the flexible sheet is pressed toward the rigid sheet, the frangible container is fractured releasing the first fluid which mixes with the second fluid to generate chemiluminescent illumination which is seen through the non-opaque portions of the first sheet by a viewer as a colorful and bright design.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### REFERENCE TO A “MICROFICHE APPENDIX”

Not applicable.

### BACKGROUND OF THE INVENTION

1. Field of the Present Disclosure

This disclosure relates generally to novelties that provide a source of illumination within and which therefore glow with colors and designs and especially to a chemically illuminated flag, or logo that may be illuminated by combining chemical agents carried within by breaking frangible elements.

2. Description of Related Art Including Information Disclosed Under 37 CFR 1.97 and 1.98

Cline, U.S. Pat. No. 3,350,553, discloses an oxyluminescent article comprising a sheet-like porous substrate impregnated with a tetrakis (disubstituted-amino) ethylene oxyluminescent material enclosed in a flexible plastic envelope, at least one portion of which permits the passage of light through it, said envelope being further characterized by having at least one area which permits the passage of light. Roberts, U.S. Pat. No. 3,808,414, discloses a device for providing chemiluminescent light from a chemical reaction of suitable compounds in the presence of a fluorescent compound. The device comprises a self-contained light transmitting package having a number of reactants stored in separate compartments, all sealed with a single sealing clip. The reactants in the separate compartments are combined in a single compartment by removal of the single sealing clip. Van Zandt, U.S. Pat. No. 4,064,428, discloses a Chemical light device that has oxalate and peroxy components in compartments separated by frangible means which is broken upon rapid acceleration or deceleration by a movable object within the device. The movable object is restrained until released by extraordinary acceleration. Hempsey, U.S. Pat. No. 4,110,818, discloses an illuminated flag or pennant adapted to be affixed to the radio antenna of a moving vehicle such as a boat or automobile and is adapted to receive electrical energy therefrom and includes means of coupling to the source of electrical energy and a fiber optic cable which couples electrical energy which has been converted to light energy to the flag at selected areas forming predetermined indicia which may be the radio operators call letters or handle. Kinn et al., U.S. Pat. No. 4,715,564, discloses a chemiluminescent kite that has a frame including at least one support member, and a cover sheet supported by the frame and adapted to catch the wind. At least one support member of the kite includes at least one self-contained source of chemiluminescent light. The source has an outer flexible container which transmits light and which contains both a first reactive composition and at least one inner breakable container. The inner container contains a second reactive composition which is adapted to react with the first reactive composition to provide chemiluminescent light. The cover sheet may be made of a translucent or transparent material so that the light is visible through the cover sheet. In addition, the cover sheet may be decorated with an opaque design. Holland et al., U.S. Pat. No. 5,158,349, discloses a method of fabricating chemical lighting devices, comprising coextensive inner and outer tubes, wherein the inner tube contains multiple, segregated oxalate components. Upon activation the device generates a distinct multi-color array of light. Giglia et al., U.S. Pat. No. 5,226,710, discloses a flexible, thin, chemiluminescent device comprised of a back sheet having sealed thereto at its edges a windowed front sheet, separation means to divide the internal cavity into a larger and a smaller compartment, the larger compartment containing a contents-releasable receptacle for one part of a two-part chemiluminescent composition and an absorbent material in the larger compartment containing the second part of the composition external to the receptacle, the smaller compartment forming an exit passageway for gases, being in open communication with the larger compartment at its upstream end, and open to the atmosphere through a vent at its downstream end, whereby gases generated during storage and use can exit harmlessly without distorting or inflating the device. The smaller compartment may contain a gas porous component which acts to separate residual liquid from escaping gas thereby preventing unwanted liquid leakage from the chemiluminescent device. Lach, U.S. Pat. No. 5,477,437, discloses a decorative flag that includes openings between opposite sides thereof, a light string on the first side of the flag having lights mounted in the openings to extend to the second side of the flag and a cover removably secured to the first side of the flag to conceal the light string. The flag includes a sleeve along an upper edge thereof for mounting the flag to a flagpole so as to hang downwardly therefrom. The sleeve includes an opening or slot for extending an outlet end of the light string therein and along the flag pole, thereby to substantially conceal the outlet end of the light string. The flag bears an ornamental design and the lights accent or form part of the design. With the outlet end of the electrical light string plugged into an electrical outlet, or into an extension cord, the lights actuate to illuminate the second side of the flag and any design thereon. With one or more additional covers, lights may be extended outwardly from opposite directions to illuminate both sides of the flag. Bay et al., U.S. Pat. No. 35132, discloses a flexible, thin, rectangular chemiluminescent device comprised of a back sheet of a laminated metal foil having heat sealed thereto at its edges a bicomponent front sheet, the first component of which is a laminated metal foil and the second component of which is a transparent or translucent polyolefin sheet, said first and second components being heat sealed to each other at their adjacent latitudinal edge, from about 20% to about 50% of the surface area of said front sheet being comprised of said first component; temporary separation means positioned so as to divide the interior area of said device into two compartments, one under each of said components, the compartment under said second component having positioned therein an absorbent material containing a solvent solution of an oxalate and, optionally, a fluorescer, and the compartment under said first component containing an activator solution. Nowak et al., U.S. Pat. No. 5,508,893, discloses a multi-colored chemiluminescent lighting device and method for making same comprising a flexible tube filled at least partially with an activator solution a plurality of ampules containing oxalate solutions, which may or may not be of the same density, wherein the ampules are disposed in the flexible tube and at least one barrier element disposed between at least two of the plurality of ampules, wherein the barrier element(s) are disposed between ampules capable of imparting different chemiluminescent colors. Douglas, U.S. Pat. No. 5,557,869, discloses an artistic display device that includes a shell having a substantially flat front wall through which an optical image is to be transmitted and a rear wall disposed substantially parallel to the front wall. A body of liquid-absorbing material essentially in the shape of a flat layer. The front and rear walls of the shell have perimetrical portions that are positioned close together in a parallel relationship with the flat body of liquid-absorbing material having a perimetrical portion that is disposed between and supported by the perimetrical portions of the walls. The rear wall being also rearwardly recessed to form a compartment. At least one set of frangible vials housed in the compartment containing respectively separate liquids which vials may be broken so as to mix the liquids to provide a chemiluminescent light-generating mixture that will then saturate the liquid-absorbing body and the liquid-absorbing body then continuing to be supported from its perimetrical portion in substantially its original flat configuration. A flat light control member disposed between the flat layer of liquid-absorbing material and the front wall of the shell for modifying light that is then generated from the liquid-absorbing material and transmitted through the front wall. Dalgleish, U.S. Pat. No. 5,567,054, discloses an illuminated bag having an open end and a closed end, a transparent pouch associated with the closed end, and chemiluminescent wand disposed within the pouch for illumination upon activating the chemiluminescent wand. Goettel-Schwartz, U.S. Pat. No. 5,575,098, discloses an illuminated display apparatus that includes embossed or quilted indicia artistic and pleasing to small children applied to a generally flat surface that is provided with a plurality of apertures disposed at locations relating to the indicia placed thereon and includes illumination devices extending through the plurality of apertures. A solid state switching device applies electrical power to the illumination devices to energize them. Electrical conductors interconnect the source of electrical energy, the switching device, and the illumination devices, all of which are embedded in a soft sponge-like material sandwiched between a backing material cooperating with the flat surface, sandwiching the electrical components therebetween. The illumination devices may be affixed to a hard frame (valance) or curtain rod for display or may be left unframed where it can function as an illuminated flag, blanket, or wall hanging. Douglas, U.S. Pat. No. 5,809,678, discloses an artistic display device that includes a shell having a substantially flat front wall through which an optical image is to be transmitted. A body of liquid-absorbing material essentially in the shape of a flat layer disposed parallel to the front wall and having a perimetrical portion that is disposed adjacent the front wall. A flat light control member disposed between the body of liquid-absorbing material and the front wall of the shell. The shell further having a rear wall disposed substantially parallel to the front wall. The walls are secured together by impervious seal. The rear wall also has a perimetrical portion positioned in supporting relationship to the perimetrical portion of the body of liquid-absorbing material. The rear wall being also rearwardly recessed inside its perimetrical portion to form at least one compartment containing a set of frangible vials having separate chemiluminescent liquids therein. The front wall peripheral edges are larger in dimension than the rear wall peripheral edges having at least one portion thereof, protruding outwardly and beyond the rear wall peripheral edges. Providing an extended space between the front wall and the rear wall peripheral edges which forms an extended flange to aid as a substructure for manipulation into independent articles for exhibition of the device. Weidenbach, U.S. Pat. No. 6,601,634, discloses a window cover apparatus that includes a window cover substrate and a mechanism for adjusting the configuration of the substrate relative to a window. Illuminating material such as phosphorescent or luminescent material is provided on or in the substrate to provide illumination in darkness. The illuminating material may contain color pigment and be configured to provide a colorful design in both daylight and darkness. Dorney, U.S. Pat. No. 6,748,681, discloses an illuminated badge system that has plastic top and bottom plates with limited flexibility. The top plate has a front face and a side wall extending inwardly and with a lip extending radially outward from the wall. The bottom plate has a rectilinear rear face and a peripheral wall extending inwardly from the rear face with a lip extending radially from the peripheral wall thereby forming a recessed back portion whereby when the front plate and the bottom plate are coupled together a top chamber and a peripheral space with a dam portion are formed. Upon breaking of an ampule located within the top chamber, a first chemiluminescent liquid located within the peripheral space intermixes with a second chemiluminescent liquid located within the ampule and the intermixed liquids fill the peripheral space, excluding the dam portion.

The related art described above discloses structures containing chemiluminescent fluids and means for causing the fluids to combine. However, the prior art fails to disclose aspects of the present invention including the use of novel compartment structures and placement of indicia, and also fails to teach the method of constructing the present invention. The present disclosure distinguishes over the prior art providing heretofore unknown advantages as described in the following summary.

### BRIEF SUMMARY OF THE INVENTION

This disclosure teaches certain benefits in construction and use which give rise to the objectives described below.

An illuminating display apparatus has a flexible sheet formed with two independent recessed areas separated by a wall. The sheet is formed with a raised perimeter surface surrounding the recessed areas. A porous wall separates one of the recessed areas into a first and a second open compartments. A closed container of a frangible material is placed within one of the compartments and the container is filled with a first chemiluminescent fluid. A second rigid sheet has a first surface area portion that is either transparent or translucent; and a second surface area portion that is opaque. The two sheets are bonded together forming closed compartments within one of which the frangible container is held in place. The compartments are filled with a second chemiluminescent fluid. When the flexible sheet is pressed toward the rigid sheet, the frangible container is fractured releasing the first fluid which mixes with the second fluid to generate chemiluminescent illumination which is seen through the non-opaque portions of the first sheet by a viewer as a colorful and bright design. The apparatus may have more than one fluid container with various fluids that produce different color lighting effects. The non-opaque surfaces may also be colored so that simple white light from the interior of the apparatus is seen in a colorful design.

A primary objective inherent in the above described apparatus and method of use is to provide advantages not taught by the prior art.

Another objective is to produce a simple device that produces a colorful design when manipulated.

A further objective is to provide the device with plural compartments so that different lighting effects may be obtained by using a colored over-sheet or by producing different colored chemiluminescent illumination.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

Illustrated in the accompanying drawing(s) is at least one of the best mode embodiments of the present invention In such drawing(s):

FIG. 1 is a front perspective view of a presently described apparatus in a first embodiment;

FIG. 2 is a rear perspective view thereof;

FIG. 3 is a perspective exploded view thereof;

FIG. 4 is a section view taken from FIG. 2 at line 6-6 showing a first sheet thereof being placed onto a second sheet thereof;

FIG. 5 is a section view taken from FIG. 2 at line 6-6 showing the sheets being bonded;

FIG. 6 is a section view taken from FIG. 2 at line 6-6 showing the compartments formed by the bonding of FIG. 5 being filled with a fluid;

FIG. 7 is a front perspective view of the presently described apparatus in a second embodiment; and

FIG. 8 is a section view taken along line 8-8 of FIG. 7.

### DETAILED DESCRIPTION OF THE INVENTION

The above described drawing figures illustrate the described apparatus and its method of use in at least one of its preferred, best mode embodiment, which is further defined in detail in the following description. Those having ordinary skill in the art may be able to make alterations and modifications what is described herein without departing from its spirit and scope. Therefore, it must be understood that what is illustrated is set forth only for the purposes of example and that it should not be taken as a limitation in the scope of the present apparatus and method of use.

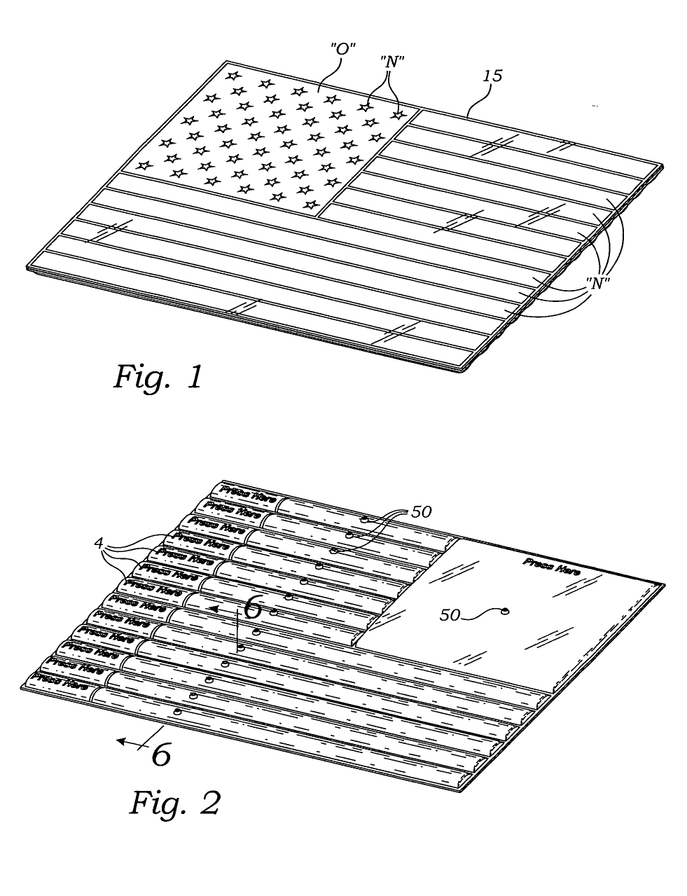

Described now in detail is an illuminating display apparatus (FIG. 1) of plastic material comprising, two plastic sheets bonded together to form compartments in which chemiluminescent fluids are mixed to generate illumination. Kinn et al., U.S. Pat. No. 4,715,564, which is hereby incorporated into this disclosure by reference, discloses self-contained source of chemiluminescent light. This source has an outer flexible container which transmits light and which contains both a first reactive composition and at least one inner breakable container which contains a second reactive composition which is adapted to react with the first reactive composition to provide chemiluminescent light. The fluids disclosed in the present description may be the compositions described by Kinn et al or similar types of compositions as are known in the art.

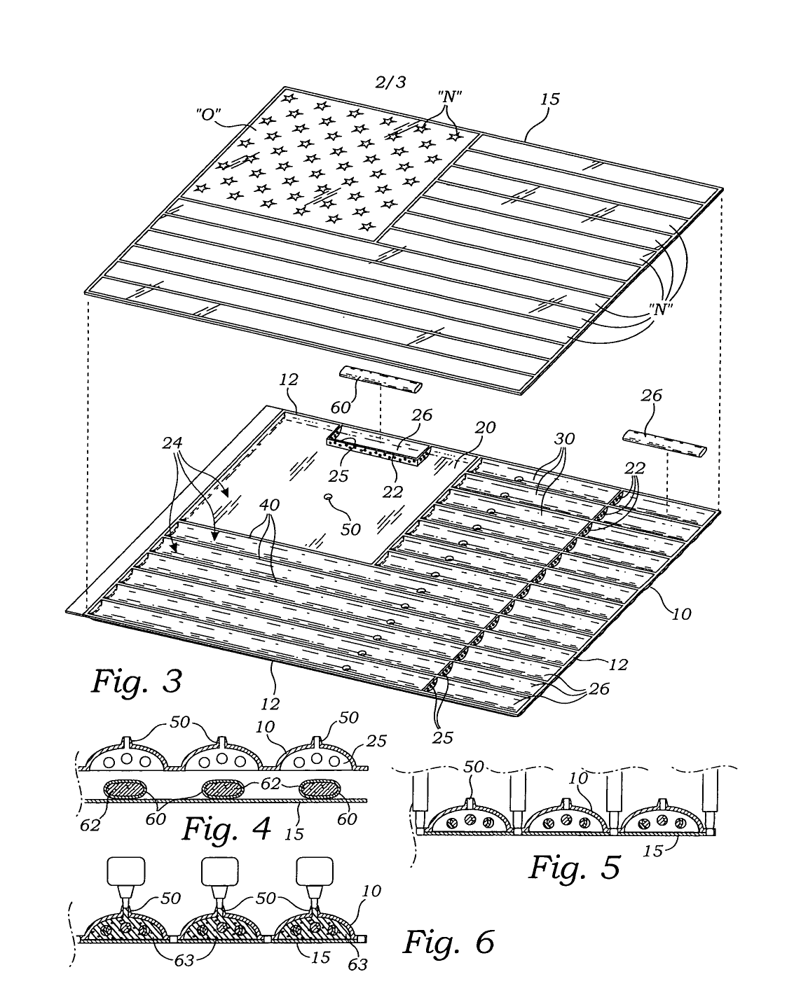

In FIG. 3 is shown a flexible sheet 10 which is formed, preferably by thermo molding, to create at least two independent recessed areas; identified by numerals 20 and 30. in FIG. 3 it is shown that these recessed areas are mutually separated by continuous walls 40. A raised perimeter surface 12 surrounds the recessed areas 20 and 30 wherein, the perimeter surface 12 defines a plane. A porous wall 22, within each of the recessed areas, separates the recessed areas into a first 24 and a second 26 compartments. Each of the first compartments 24 provides a fill-nipple 50 as best seen in FIGS. 4-6.

A closed container 60 made of frangible material is positioned within each of the second compartments 26. The containers 60 each contain a first chemiluminescent fluid component 62.

The continuous walls 40, and the porous walls 22 provide a surface 25 that is coplanar with the plane defined by the raised perimeter 10, i.e., these elements are coplanar.

A rigid sheet 15 is formed with a first surface portion 17 that is either transparent or translucent but not opaque. A second surface portion 19 is opaque so that the non-opaque portions and the opaque portions form a design.

The second sheet 15 is thermally bonded to the first sheet 10 continuously around the perimeter surface 12 and on each of the wall surfaces 25 and 40 coplanar with the plane defined by the raised perimeter surface. This forms the recessed areas into closed compartments containing a second chemiluminescent fluid 63. The two fluid components 62 and 63 generate chemiluminescent light when mixed.

In the embodiment shown in FIGS. 1-6, the independent recessed areas 30 comprise a plurality of elongate side-by-side recessed areas corresponding to the stripes of the American flag. This area is not opaque so that that can shine through. The sheet 15 may be colored to resemble the red and white strips of the American flag. Alternately, the entire surface of the strips may be clear or frosted with the chemical generated light being of an appropriate color to resemble the colors of the stripes.

A further one of the two recessed areas 20 corresponds to the star field of the American flag. On the rigid sheet 15 a surface portion corresponding to the star field of sheet 10 is opaque except for a plurality of transparent star shaped areas 15′ corresponding in size and position to the stars of the American flag. Light produced within the closed compartments shines through the non-opaque surface areas, marked “N” in the figures. Opaque areas are marked with “O.” Preferably, the flexible sheet 10 is opaque while the rigid top sheet 15 is partly opaque and partly non-opaque as shown in the figures.

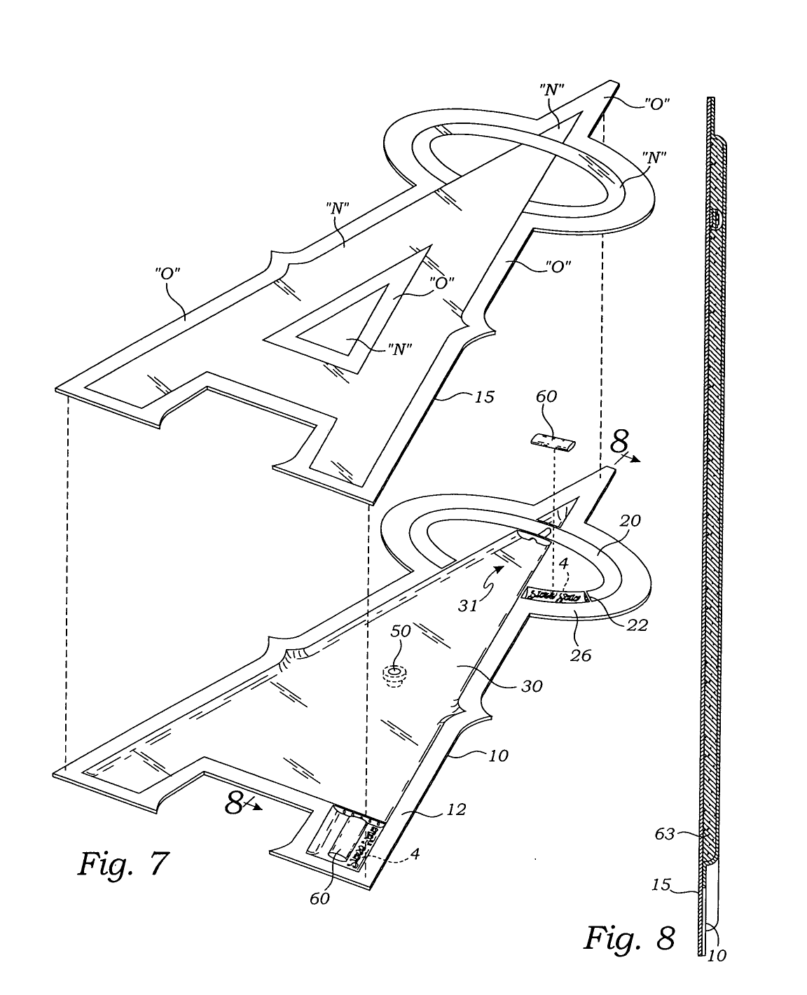

In a still further embodiment, one of the at least two independent recessed areas conforms to the shape of a letter “A” and a further one of the recessed areas conforms to the shape of an angle's halo as shown in FIG. 7. This is the famous emblem of the Los Angeles Angels of Anaheim. A similar construction may be employed for the emblems of other sport teams and the insignia or trademarks of other entities. In the embodiment of FIGS. 7 and 8 the container 60 is placed in one of the legs of the “A” conformation. The fluids in this container 60 and within the open area 30 preferably mix to product a white illumination, while fluids in the container 60 and halo area 20 mix to produce a yellow colored illumination.

The present invention encompasses a method for constructing the above described illuminating display apparatus and includes the steps of, forming a flexible sheet with at least two independent recessed areas mutually separated by at least one continuous wall, a raised perimeter surface surrounding the recessed areas, with the perimeter surface defining a plane, a porous wall within each said recessed area, each said porous wall separating one of the recessed areas into a first and a second compartments with each of the first compartments providing a fill-nipple. The method further includes the step of placing a frangible closed container having a first chemiluminescent fluid component within each of the second compartments and forming a rigid sheet having a first surface portion that is preferably translucent, and a second surface portion that is opaque. The second sheet is bonded to the first sheet continuously around the perimeter surface and on each of the wall surfaces coplanar with the plane defined by the raised perimeter surface, thereby forming the recessed areas into closed compartments. The closed compartments are filled with a second chemiluminescent fluid so that when mixed with the first fluid chemiluminescent light is generated.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. An illuminating display apparatus of plastic material comprising:
a flexible sheet formed with:
at least two independent recessed areas mutually separated by at least one continuous wall;
a raised perimeter surface surrounding the recessed areas, the perimeter surface defining a plane;
a porous wall within each said recessed area, each said porous wall separating one of the recessed areas into a first and a second compartments;
each of the first compartments providing a fill-nipple communicating therewith;
and a closed container of frangible material positioned within each said second compartment, each said closed container enclosing a first chemiluminescent fluid component;
wherein the at least one continuous wall, and each said porous wall provides a surface coplanar with the plane defined by the raised perimeter;
a rigid sheet formed with:
a first surface portion that is one of transparent and translucent; and
a second surface portion that is opaque;
wherein the second sheet is thermally bonded to the first sheet continuously around the perimeter surface and on each of the wall surfaces coplanar with the plane defined by the raised perimeter surface, thereby forming the recessed areas into closed compartments containing a second chemiluminescent fluid; the two fluid components generating chemiluminescent light when mixed.

2. The apparatus of claim 1 wherein one of the at least two independent recessed areas comprises a plurality of elongate side-by-side recessed areas corresponding to the stripes of the American flag; a further one of the two recessed areas corresponding to the star field of the American flag.

3. The apparatus of claim 2 wherein the star field of the rigid sheet is opaque except for a plurality of transparent star shaped areas within the star field, the star shaped areas corresponding to the stars of an American flag.

4. The apparatus of claim 2 wherein the star field of the rigid sheet is opaque except for a plurality of translucent star shaped areas within the star field, the star shaped areas corresponding to the stars of an American flag.

5. The apparatus of claim 1 wherein one of the at least two independent recessed areas conforms to the shape of a letter “A” and a further one of the recessed areas conforms to the shape of an angle's halo.

6. A method for constructing an illuminating display apparatus of plastic material comprising the steps of:
forming a flexible sheet with:
at least two independent recessed areas mutually separated by at least one continuous wall;
a raised perimeter surface surrounding the recessed areas, the perimeter surface defining a plane;
a porous wall within each said recessed area, each said porous wall separating one of the recessed areas into a first and a second compartments;
each of the first compartments providing a fill-nipple communicating therewith;
placing a frangible closed container having a first chemiluminescent fluid component within each said second compartment;
forming a rigid sheet formed with:
a first surface portion that is one of transparent and translucent; and
a second surface portion that is opaque;
bonding the second sheet to the first sheet continuously around the perimeter surface and on each of the wall surfaces coplanar with the plane defined by the raised perimeter surface, thereby forming the recessed areas into closed compartments; and
filling the closed compartments with a second chemiluminescent fluid; the two fluid components generating chemiluminescent light when mixed.
